(19) United States
(12) Patent Application Publication
(10) Pub. No.: US 2010/0068919 A1
(43) Pub. Date: Mar. 18, 2010

(54) CABLE CONNECTOR

(75) Inventors: Kousuke Taketomi, Yamato (JP); Hiroshi Shimoyama, Isehara-shi (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/302,623

(22) PCT Filed: May 31, 2007
(86) PCT No.: PCT/US2007/012778

§ 371 Date: Apr. 13, 2009

(30) Foreign Application Priority Data
May 31, 2006 (JP) 2006-150813

(51) Int. Cl. H01R 12/24

(52) U.S. Cl. 439/499

(57) ABSTRACT

A cable connector for connecting a flat cable having lead wires to a circuit board including a housing carrying terminals and an actuator moveable between a first position to enable insertion of the flat cable and a second position to connect the lead wires to the terminals. The actuator has a main body and further includes first shafts extending from opposite sides of the main body as well as second shafts carried in positions for engaging at least part of the terminals. The first shafts are supported by first bearing parts on auxiliary connector securing members carried on opposite sides of the housing while the second shafts are supported by second bearing parts of the terminals engaging the second shafts. When the actuator is in the first position, moment forces are generated on the first shafts and second shafts respectively by the first bearing parts and the second bearing parts which oppose movement of the actuator from the first position to the second position. The housing also includes concave and convex side portions which interact with the first shafts to further assist in the retention of the actuator in the first position.

### BACKGROUND OF THE INVENTION

The present invention relates to a connector for a cable. Conventionally, in order to connect flat cables, being often referred to as a flexible printed circuit (FPC) or a flexible flat cable (FFC), and each having flexibility, a connector for a cable (hereinafter referred to as “cable connector”) such as an FPC connector and an FFC connector has been used (for example, refer to Utility Model Registration No. 3094560).

FIG. 6 is a perspective view indicating a conventional cable connector.

As shown in FIG. 6, the cable connector includes a housing 301 being formed of an insulating material such as synthetic resin or the like, and a plurality of first terminals 303 and a plurality of second terminals 304, being formed of a conductive material such as metal or the like, and being held by the housing 301. On the upper surface of the housing 301, an actuator 302 being formed of insulating material such as synthetic resin or the like is disposed. The actuator 302 is rotatably mounted on the housing 301 and rotates between its open position as shown in the figure and its closed position as not shown in the figure. In a state in which the actuator 302 is situated in the open position, a flat cable 305 is inserted from opening parts of the housing 301. When the flat cable 305 is inserted into the back of the opening part, the actuator 302 is then rotated up to the closed position by being operated by the operator's fingers or the like.

Each of the first terminals 303 has an upper arm part 306 and a lower arm part 308, each extending in a direction of insertion-and-extraction of the flat cable 305, and the upper arm part 306 enters into a recessed groove 311 being formed in the actuator 302. An interlocking block 312 being disposed within the recessed groove 311 is positioned within a rotary supporting recessed groove 307 being formed at the tip of the upper arm part 306. When the actuator 302 rotates up to the closed position, the interlocking block 312 of rectangular cross section is rotated within the rotary supporting recessed groove 307, thereby pressing the flat cable 305 downward. Thus, a connecting part exposed on the lower surface of the flat cable 305 is brought into contact with a projection at the tip of the lower arm part 308, and is connected with the first terminal 303. Similarly, the connecting part exposed on the lower surface of the flat cable 305 is also brought into contact with a projection at the tip of an arm part 309 provided by each of the second terminals 304, and is connected with the second terminal 304.

In the above conventional cable connector, however, since a lock mechanism is not activated when the actuator 302 is in the open position, the actuator 302 unnecessarily rotates to the closed position upon insertion of the flat cable 305, and thereby it becomes difficult to perform the operation of inserting the flat cable 305. That is, when the actuator 302 is in the open position, the orientation of the actuator 302 is maintained under its own weight. Therefore, for example, if the flat cable 305 makes contact with the actuator 302 upon insertion of the flat cable 305, the actuator 302 may rotate to the closed position by the impact of the contact. In this case, it is necessary for an operator to return the actuator 302 to the open position and repeat the operation of inserting the flat cable 305, thereby complicating the operation.

### SUMMARY OF THE INVENTION

It is an object of the present invention, in order to solve the above-mentioned problem encountered by the conventional cable connector, to provide a user-friendly cable connector, in spite of a simple construction, by rendering an actuator capable of changing its orientation between a first position to enable insertion of a flat cable and a second position to electrically connect terminals with lead-wires of the inserted flat cable to prevent the actuator from unnecessarily changing its position from the first position to the second position in response to forces generated against the actuator as a result of insertion of the flat cable into the connector.

To this end, a cable connector of the present invention comprises: a housing provided with inserting holes through which a flat cable is inserted; terminals being mounted on the housing and electrically connected to lead-wires of the flat cable; an actuator capable of changing its orientation between a first position to enable insertion of the flat cable and a second position to connect the lead-wires of the inserted flat cable to the terminals, the actuator having a main body nearly parallel to a direction of insertion-and-extraction of the flat cable in the second position, first shafts being disposed on both sides of the main body respectively and second shafts being disposed in positions corresponding to at least part of the terminals; and auxiliary connector securing members mounted on both sides of the housing respectively, wherein the auxiliary connector securing members have first bearing parts supporting the first shafts respectively, the part of the terminals has second bearing parts supporting the second shafts, and the actuator maintains its orientation in the first position under moment forces exerted on the first shafts and the second shafts by the first bearing parts and the second bearing parts respectively.

In a cable connector according to another aspect of the present invention, in the first position, a difference in height between positions of points at which the first shafts abut on the first bearing parts and positions of points at which the second shafts abut on the second bearing parts is larger than a difference in height, when the actuator is removed, between positions of points at which the first bearing parts abut on the first shafts and positions of points at which the second bearing parts abut on the second shafts, wherein, since forces exerted on the first shafts by the first bearing parts and forces exerted on the second shafts by the second bearing parts are opposed to each other, and a point of action of the forces exerted on the first shafts by the first bearing parts is located ahead of a point of action of the forces exerted on the second shafts by the second bearing parts, with respect to a direction of movement of a front end of the main body when the actuator changes its orientation from the first position to the second position, a force to change its orientation in the opposite direction of the second position acts on the actuator under the forces exerted on the first shafts by the first bearing parts and the forces exerted on the second shafts by the second bearing parts.

In a cable connector according to a further aspect of the present invention, the housing has concave portions and convex portions being formed at side parts, respectively wherein in the second position, the first shafts are accommodated in the concave portions respectively, and in the first position, ends of the first shafts abut on the convex portions respectively.

Other objects, features and advantages of the invention will be apparent from the following detailed description taken in conjunction with the accompanying drawings.

### BRIEF DESCRIPTION OF THE DRAWINGS

FIG. 1 is a perspective view when an actuator of a cable connector in a preferred embodiment of the present invention is in the open position;

FIG. 2 is a perspective view when the actuator of the cable connector in the preferred embodiment of the present invention is in the closed position;

FIG. 3 is a cross-sectional view when the actuator of the cable connector in the preferred embodiment of the present invention is in the closed position, and an arrowed line sectional view A-A in FIG. 2;

FIG. 4 is a cross-sectional view when the actuator of the cable connector in the preferred embodiment of the present invention is in the closed position, and an arrowed line sectional view B-B in FIG. 2;

FIGS. 5A and 5B are partial cross-sectional views when the actuator of the cable connector in the preferred embodiment of the present invention is in the open position; and

FIG. 6 is a perspective view indicating a conventional cable connector.

### DESCRIPTION OF THE PREFERRED EMBODIMENTS

Preferred embodiments of the present invention will be described below in detail with reference to the accompanying drawings.

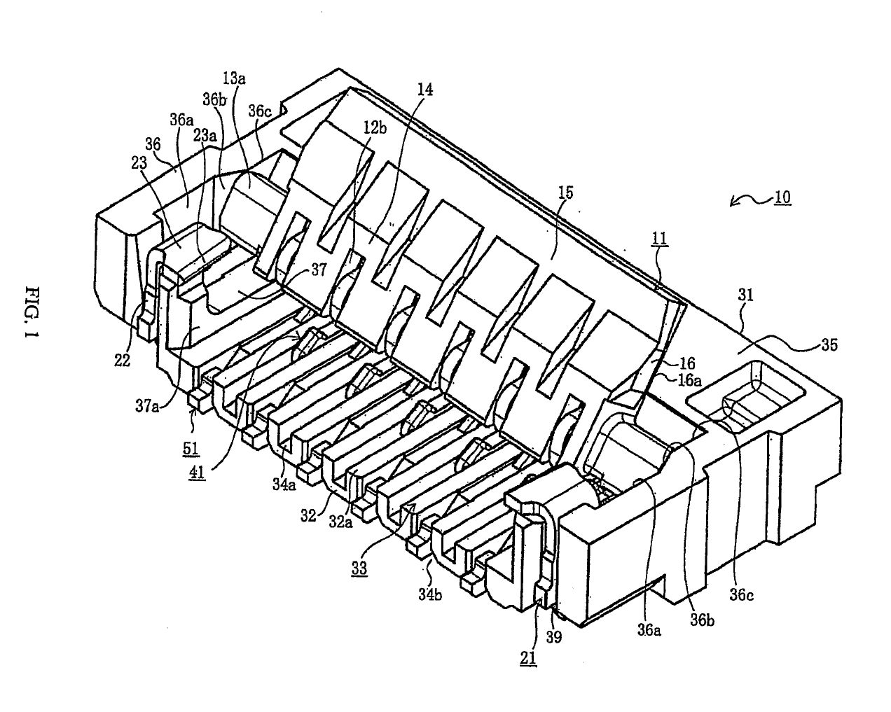

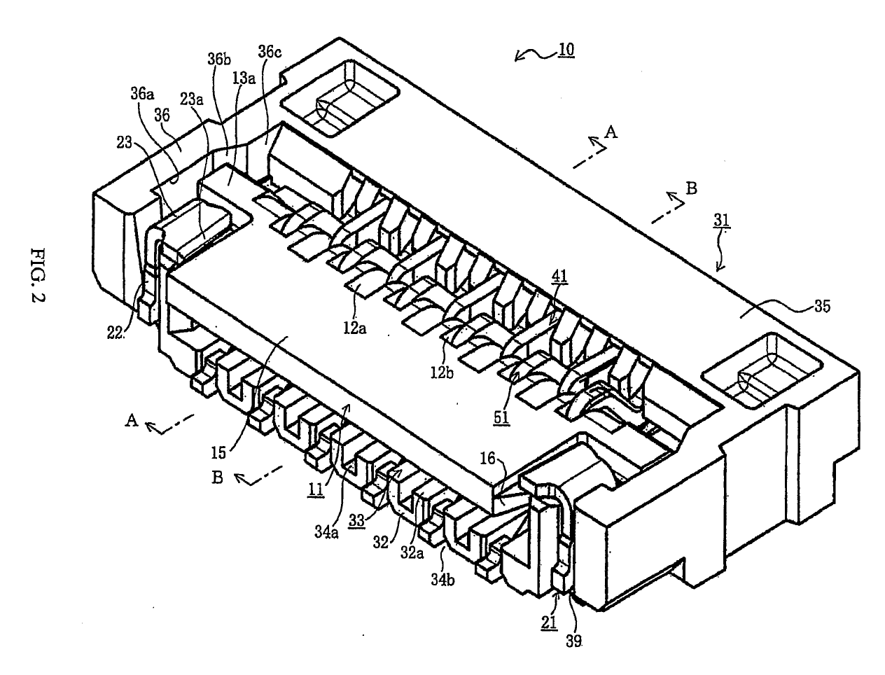

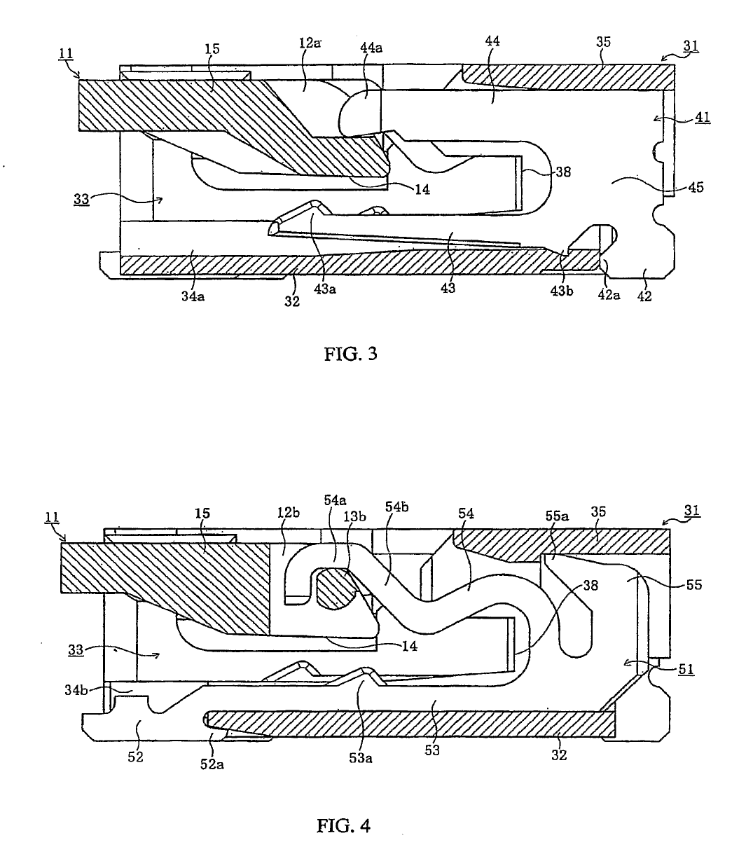

FIG. 1 is a perspective view when an actuator of a cable connector in a preferred embodiment of the present invention is in the open position. FIG. 2 is a perspective view when the actuator of the cable connector in a preferred embodiment of the present invention is in the closed position. FIG. 3 is a cross-sectional view when the actuator of the cable connector in a preferred embodiment of the present invention is in the closed position, and an arrowed line sectional view A-A in FIG. 2. FIG. 4 is a cross-sectional view when the actuator of the cable connector in a preferred embodiment of the present invention is in the closed position, and an arrowed line sectional view B-B in FIG. 2.

In these figures, a reference numeral 10 designates a connector as a cable connector in the preferred embodiment, and the connector 10 is mounted on a surface of a substrate such as a circuit board or the like (not illustrated), and is used for electrically connecting a flat cable, which is not illustrated and referred to as a flexible circuit board, a flexible flat cable or the like. In this case, the lower surface as viewed in FIGS. 3 and 4 is a mounting surface of the connector 10, and is opposed to the mounting surface of the substrate. For example, the flat cable is a flat flexible cable being called as an FPC, an FFC, or the like, and any kind of cable is acceptable if it is a flat cable provided with lead-wires. In this embodiment, references to directions such as up, down, left, right, front, rear, and the like, used for explaining the structure and movement of each part of the cable connector 10, are not absolute, but relative. These reference are appropriate when each part of the cable connector 10 is situated in the position shown in the figures. If the position of each part of the cable connector 10 changes, however, it is assumed that these references are to be changed according to the change in the position of each part of the connector 10.

At this moment, the connector 10 comprises a housing 31 being integrally formed of insulating material such as synthetic resin or the like, and an actuator 11 being integrally formed of insulating material such as synthetic resin or the like, and being mounted on the housing 31 so as to be able to change its orientation. That is, the actuator 11 is mounted on the housing 31 so as to change its position to be situated in the open position as a first position and the closed position as a second position.

The housing 31 includes a lower part 32, an upper part 35, right and left side parts 36, and inserting holes 33 being formed among the lower part 32, the upper part 35, and the side parts 36, and serving as opening parts for inserting and extracting an end portion of the flat cable from the front (the left side as viewed in FIGS. 3 and 4). The flat cable is inserted toward the right side as viewed in FIGS. 3 and 4. In this embodiment, for the sake of convenience, it is decided that each inlet side of the inserting holes 33 (the left side as viewed in FIGS. 3 and 4) is referred to as the front side of the connector 10, and each back of the inserting holes 33 (the right side as viewed in FIGS. 3 and 4) is referred to as the rear side of the connector 10. At the backs within the inserting holes 33, an abutting part 38 on which the tip of the flat cable abuts is disposed.

In the housing 31, a plurality of terminal receiving grooves are formed in which metal terminals are fitted. In the present preferred embodiment, the terminals include a first terminal 41 and a second terminal 51, and each of the terminal receiving grooves includes a first terminal receiving groove 34a in which the first terminal 41 is fitted, and a second terminal receiving groove 34b in which the second terminal 51 is fitted. In the example as shown in the drawings, the terminal receiving grooves in even-number positions are the first terminal receiving grooves 34a, and the terminal receiving grooves in odd-number positions are the second terminal receiving grooves 34b. For example, eleven pieces of the first terminal receiving grooves 34a and the second terminal receiving grooves 34b are formed in total at a pitch of about 0.3 mm. The pitch and the number of the terminal receiving grooves can be suitably changed. The first terminal receiving grooves 34a and the second terminal receiving grooves 34b are alternately disposed so as to be adjacent to each other. Further, the first terminals 41 and the second terminals 51 are not always required to be fitted in all the first terminal receiving grooves 34a and the second terminal receiving grooves 34b, and it is possible to suitably reduce the number of first terminals 41 and the number of second terminals 51 based upon the arrangement of the lead-wires contained in the flat cable.

In addition, side shoulder portions 37 are formed adjacent to the side portions 36 on both sides of the lower portion 32. The side shoulder portions 37 are shoulder portions extending in the direction of inserting and extracting the flat cable, that is, in the direction of insertion-and-extraction of the flat cable, and the upper surfaces thereof are situated in a higher position than the upper surface 32a of the lower portion 32. In the side shoulder portions 37, slit-shaped auxiliary securing member receiving recess portions 39 extending in the direction of insertion-and-extraction of the flat cable are formed, and auxiliary connector securing members 21 being commonly known as nails are inserted into auxiliary securing member receiving recess portions 39, thereby being mounted on the housing 31.

Preferably, the auxiliary connector securing members 21 are formed by providing a metal plate with machining such as punching, bending or the like. Each of the auxiliary connector securing members 21 includes a flat main body 22 extending in the direction of insertion-and-extraction of the flat cable and in the direction vertical to the mounting surface, and a locking portion 23 being integrally connected to the upper edge of the front end of the main body 22 and extending in a direction parallel to the mounting surface. The locking portion 23 is formed by bending a member projecting above from the upper edge of the front end of the main body 22 so that the tip edge 23a may be directed to the inside of the housing 31. Consequently, the right and left locking portions 23 are formed so that each other's tip edge 23a may face each other. In addition, since the locking portions 23 are integrally connected to the main body 22 through bending portions, the locking portions 23 can resiliently be deformed to a certain degree, and the right and left tip edges 23a can be displaced in the right and left direction.

Each of the tip edges 23a is linear, and is formed so as to be inclined to the direction of insertion-and-extraction of the flat cable. More particularly, the tip edge 23a is formed so that the part may be inclined to a center line extending in the anteroposterior direction of the housing 31 on the surface parallel to the mounting surface, and the extension line thereof may cross the center line ahead of the housing 31. The right and left locking portions 23, including the tip edges 23a, are disposed so as to be symmetric to the center line. Thus, the distance between the right and left tip edges 23a is wider at the backs of the inserting holes 33, namely at the rear side, and narrower at the inlet sides of the inserting holes 33, namely at the front side. The side surfaces 37a of the right and left side shoulder portions 37, and the front side ends of the tip edges 23a function as the guides of the inserting holes 33.

The auxiliary connector securing members 21 also have mounting portions 24 to be described later, which are connected to the lower ends of the main body 22 and the mounting portions 24 are fixed on the surface of the substrate by soldering or the like. This reinforces the mounting of the connector 10 on the substrate, preventing the connector 10 from disengaging from the substrate.

The auxiliary connector securing members 21 are further provided with first bearing parts 25 to be described later, which are formed at the upper end behind the locking portions 23 in the main body 22. The first bearing parts 25 extend in the direction of insertion-and-extraction of the flat cable, and support the first shafts 13a being formed on both sides of the main body 15 of the actuator 11 from below.

Thus, the actuator 11 includes the main body 15 being a nearly rectangular thick plate member, a plurality of terminal accommodating recess parts being formed in the main body 15, the first shafts 13a as shafts being formed so as to project outward from both sides of the main body 15, the plate-like locked portions 16 being formed so as to project outward from both sides of the main body 15, as in the case of the first shafts 13a, and pressing parts 14 being disposed on the lower face of the main body 15. The pressing parts 14 press the flat cable being inserted from the inserting holes 33 downwardly, namely toward the direction of the mounting surface, when the actuator 11 is situated in the closed position. The pressing parts 14 also enable insertion of the flat cable when the actuator 11 is situated in the open position.

The first shafts 13a being formed so as to project outward from both sides of the main body 15 are situated in the positions opposite to the right and left side parts 36 of the housing 31, however, on the other hand, when the actuator 11 is situated in the closed position, as shown in FIG. 2, the first shafts 13a are situated in the positions corresponding to concave portions 36a being formed on the inside of the side parts 36. At this time, the first shafts 13a are supported by the first bearing parts 25, with no abutment on the side parts 36.

On the inside of the side parts 36, the concave portions 36a, tilting parts 36b, and convex portions 36c are formed so as to sequentially line in the direction of insertion-and-extraction of the flat cable. When the actuator 11 changes its orientation from the closed position to the open position, the ends of the first shafts 13a abut on the convex portions 36c, while being guided by the tilting parts 36b. The distance between the opposed right and left convex portions 36c is shorter than the distance between the respective ends of the right and left first shafts 13a. Consequently, when the actuator 11 is situated in the open position, the actuator 11 is pinched from both sides by the right and left convex portions 36c, enabling the actuator 11 to be held in the open position.

Each of the terminal accommodating recess parts contains a first terminal accommodating recess part 12a for accommodating a backstop 44a lying at the tip of an upper arm part 44 of the first terminal 41, and a second terminal accommodating recess part 12b for accommodating a second bearing part 54a lying at the tip of an upper arm part 54 of the second terminal 51. The number and the position of the first terminal accommodating recess parts 12a and the second terminal accommodating recess parts 12b correspond to the first terminal receiving grooves 34a and the second terminal receiving grooves 34b. In addition, as shown in FIG. 4, a second shaft 13b of the actuator 11 is disposed in each of the second terminal accommodating recess parts 12b, and the second shafts 13b are engaged with the second bearing parts 54a. Since the second bearing parts 54a support the second shafts 13b from above, shifts of the second shafts 13b to the upward direction are limited. Therefore, the second bearing parts 54a prevent the actuator 11 from disengaging from the housing 31.

Then, as shown in FIG. 2, the main body 15 becomes approximately parallel to the direction of insertion-and-extraction of the flat cable when the actuator 11 is situated in the closed position, and as shown in FIG. 1, the main body 15 forms an angle of 90 degrees or more with respect to the direction of insertion-and-extraction of the flat cable when the actuator 11 is situated in the open position.

Furthermore, when the actuator 11 is situated in the closed position, the locked portions 16 are formed in the positions anterior to the first shafts 13a so as to engage with the locking portions 23. In this case, as shown in FIG. 2, the locking portions 23 hang over the locked portions 16, preventing the actuator 11 from changing its orientation from the closed position to the open position. That is to say, the locked portions 16 and the locking portions 23 function as locking mechanisms for locking the actuator 11 in the closed position and preventing the actuator 11 from being opened. The tip edges 16a of the locked portions 16 are linear and formed so as to be parallel to the direction of insertion-and-extraction of the flat cable. To be more specific, the tip edges 16a are parallel to a center line extending in the anteroposterior direction of the housing 31 on the surface parallel to the mounting surface.

Then, as shown in FIG. 3, each of the first terminals 41 has an approximately U shape, and contains a lower arm part 43 as a first arm part and an upper arm part 44 as a second arm part, extending in the direction of insertion-and-extraction of the flat cable, and a connecting part 45 extending in a direction perpendicular to the direction of insertion-and-extraction and linking the base part of the lower arm part 43 and the base part of the upper arm part 44.

At this moment, the lower arm part 43 functions as a contact piece electrically connected to the lead-wires of the flat cable, and contains a contacting part 43a projecting in the vicinity of the tip thereof (the left end as viewed in FIG. 3). In addition, to the rear end of the connecting part 45, a tail part 42 is connected as a substrate connecting part, projecting downward and being connected to a connecting pad to be formed on the substrate surface by soldering or the like. Further, a projection 43b projecting downward is formed at the base part of the lower arm part 43, and an abutting part 42a is formed at the front end of the tail part 42.

When the actuator 11 is situated in the closed position, the backstops 44a at the tips of the upper arm parts 44 enter into the first terminal accommodating recess parts 12a and press the pressing part 14 downwardly, namely toward the direction of the mounting surface.

The first terminals 41 are then inserted and fitted in the first terminal receiving grooves 34a from the rear side of the housing 31 (the right side as viewed in FIG. 3). In this case, the upper arm parts 44 and approximately linear upper end parts of the connecting parts 45 abut on the lower surface of the upper part 35, the projections 43b grab the floor surfaces of the first terminal receiving grooves 34a, and further the abutting parts 42a abut on the rear end surface of the lower part 32, thereby the first terminal 41 being fixed to the housing 31.

As shown in FIG. 4, each of the second terminals 51 contains a lower arm part 53 as a linear first arm part extending in the direction of insertion-and-extraction of the flat cable, an upper arm part 54 as an approximately S-shaped second arm part, and a connecting part 55 extending in a direction perpendicular to the direction of insertion-and-extraction and being connected to a connecting portion between the base part of the lower arm part 53 and the base part of the upper arm part 54.

To the tips of the lower arm parts 53 (the left end as viewed in FIG. 4), tail parts 52 are connected as substrate connecting portions, projecting downward and being connected by soldering or the like to connecting pads to be formed on the substrate surface. The lower arm parts 53 function as contact pieces being electrically connected to the lead-wires of the flat cable, and contain contact parts 53a formed so as to project upward between the tip and the base part thereof. On the other hand, a projection 52a projecting backward is formed at the rear end of the tail part 52, and a projection 55a is formed at the upper edge of the front end of the connecting part 55.

The second bearing part 54a at the tip of the upper arm part 54 is connected through the tilting part 54b being formed so as to be situated obliquely upward from the base part side to the tip side. Thus, the second shafts 13b of the actuator 11 are engaged with the second bearing parts 54a and subjected to downward forces exerted by the second bearing parts 54a.

Then, the second terminals 51 are inserted and fitted in the second terminal receiving grooves 34b from the front side of the housing 31 (the left side as viewed in FIG. 4). In this case, the approximately linear lower ends of the lower arm parts 53 abut on the floor surfaces of the second terminal receiving grooves 34b, the projections 55a grip the lower surface of the upper part 35, and further the projections 52a of the tail parts 52 grip the lower end of the front end surface in the lower part 32 of the housing 31, and thereby the second terminals 51 is fixed to the housing 31.

Meanwhile, in the first terminals 41, the tail parts 42 are situated at the rear end of the housing 31, whereas in the second terminals 51, the tail parts 52 are situated at the front end of the housing 31. Then, as described above, the first terminals 41 and the second terminals 51 are alternately fitted in the housing 31. For this reason, the alignment of the tail parts 42, the tail parts 52, and the connecting pads or the like being formed on the mounting surface of the substrate so as to correspond to said tail parts forms, when viewed from above the connector 10, a zigzag form alternately being off in a transverse direction with respect to the direction of alignment of terminals, namely a direction perpendicular to the surfaces of FIGS. 3 and 4. Therefore, even if a pitch between the first terminal 41 and the second terminal 51 adjacent to each other is narrow, it is possible to widen the distance between the tail part 42 and the tail part 52, and the distance between the connecting pads or the like corresponding to each of these tail parts. For this reason, it is possible to manufacture the connecting pads or the like with ease, and also to prevent the formation of a solder bridge to avoid any short-circuit from arising between the adjacent connecting pads, at the time of soldering the tail part 42, the tail part 52, and connecting pads or the like corresponding to said tail parts.

Further, in each of the second terminals 51, the position of the contact part 53a with respect to the direction of insertion-and-extraction of the flat cable is situated nearer the rear end of the housing 31 than the position of the contact part 43a in the first terminal 41. This aims for equalizing the electrical resistance at the first terminal 41 and the second terminal 51 by approximately equalizing the length of the electrically-conducting path from the contact part 43a to the tail part 42, to the length of the electrically-conducting path from the contact part 53a to the tail part 52. Since this separates the positions at which the adjacent lead-wires of the flat cable are electrically connected to the first terminals 41 and the second terminals 51 respectively, it enables to prevent the crosstalk between the adjacent lead-wires from generating.

As shown in FIG. 1, when the actuator 11 is situated in the open position, the pressing parts 14 are directed obliquely upward. Since the distance between the actuator 11 and the contact part 43a of the first terminals 41, and the distance between the actuator 11 and the contact part 53a of the second terminals 51 are sufficiently wide, the end of the flat cable being inserted from the inserting hole 33 is inserted without being subjected to any contact pressure or with being subjected to a slight contact pressure from the contact parts 43a and the contact parts 53. Therefore, a formation of ZIF (Zero Insertion Force) structure is thereby substantially realized.

Next, the force exerted on the actuator 11 being situated in the open position when the flat cable is not connected will be described.

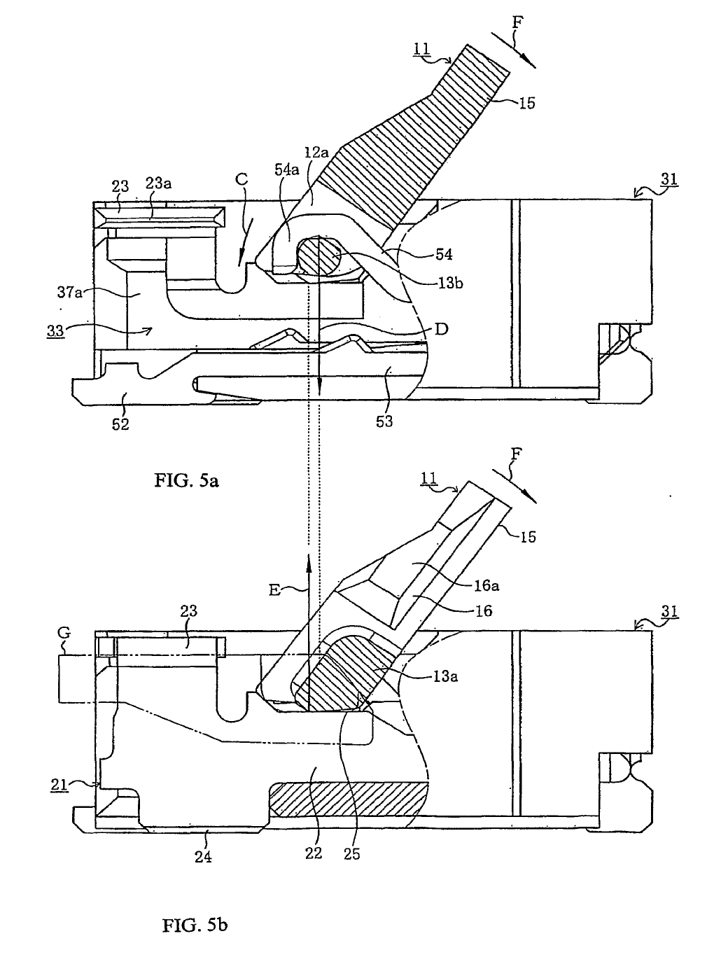

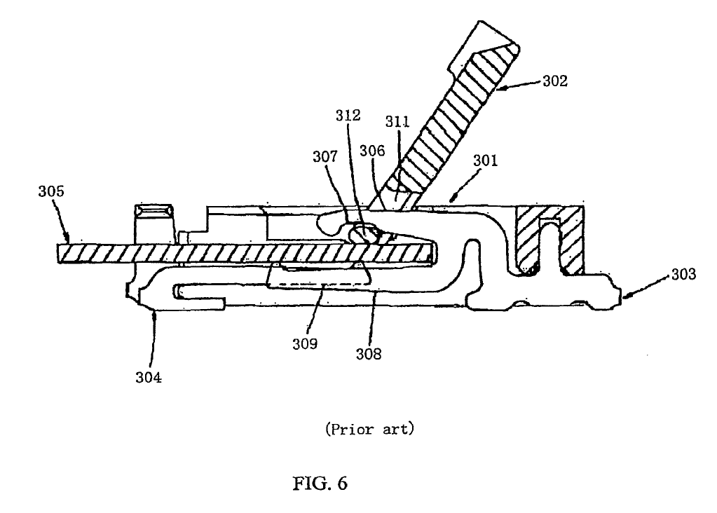

FIGS. 5A and 5B are partial cross-sectional views of a state in which, the actuator of the cable connector in the preferred embodiment of the present invention is situated in the open position. FIG. 5A is a partial cross-sectional view depicting sites of the second terminals, and FIG. 5B is a partial cross-sectional view depicting sites of the auxiliary connector securing members.

In the present embodiment, the tail parts 42 of the first terminals 41 and the tail parts 52 of the second terminals 51 are connected by soldering to the conductive pads or the like being formed on the surface of the substrate, and the mounting parts 24 of the auxiliary connector securing members 21 are connected by soldering to the connecting pads being formed on the surface of the substrate, and thereby the connector 10 is mounted on the surface of a substrate such as a circuit board or the like.

Before connecting the flat cable, the actuator 11 is set to the open position, as shown in FIGS. 5A and 5B. In this case, the first shafts 13a of the actuator 11 abut on the abutting surfaces of the first bearing parts 25 of the auxiliary connector securing members 21 and are supported from below, whereas the second shafts 13b abut on the abutting surfaces of the second bearing parts 54a of the second terminals 51 and thereby upward movement thereof is limited. A difference in height between the positions of the lower ends of the first shafts 13a and the positions of the upper ends of the second shafts 13b when the actuator 11 is situated in the open position is larger than a difference in height between the positions of the abutting surfaces of the first bearing parts 25 of the auxiliary connector securing members 21 and the positions of the abutting surfaces of the second bearing parts 54a of the second terminals 51 when the actuator 11 is removed. Therefore, when the actuator 11 is situated in the open position, the second bearing parts 54a are in a state of being pressed upward by the second shafts 13b, and the upper arm parts 54 of the second terminals 51 are in a state of being resiliently deformed.

Thus, in the second bearing parts 54a being disposed at the tips of the upper arm parts 54, a force as indicated by the arrow C in FIG. 5A is generated by spring forces that the flexibly-deformed upper arm parts 54 exert in order to return to the shape that it used to have. For this reason, the second shafts 13b are subjected to a downward force exerted by the second bearing parts 54a as indicated by the arrow D in FIG. 5A. Hence, the first shafts 13a are subjected to an upward force exerted by the first bearing parts 25 as indicated by the arrow E in FIG. 5B, as the reaction force against the force indicated by the arrow D.

A point at which downward forces exerted by the second bearing parts 54a act on the upper surfaces of the second shafts 13b, namely a point of action of the force indicated by the arrow D, and a point at which upward forces exerted by the first bearing parts 25 act on the lower surfaces of the first shafts 13a, namely a point of action of the force indicated by the arrow E do not conform in the direction of insertion-and-extraction of the flat cable, that is, there is a displacement between the two points. Comparing the arrow D in FIG. 5A with the arrow E in FIG. 5B, it shows that the point of action of the force indicated by the arrow D is located at the backs of the inserting holes 33, and the point of action of the force indicated by the arrow E is located on the inlet sides of the inserting holes 33. That is, with respect to the direction of movement of the front end of the main body 15 in case that the actuator 11 changes its orientation from the open position to the closed position, the point at which the downward forces exerted by the second bearing parts 54a act on the upper surfaces of the second shafts 13b is located behind, and the point at which the upward forces exerted by the first bearing parts 25 act on the lower surfaces of the first shafts 13a is located ahead.

As the result, a moment causing the actuator 11 to change its orientation in the clockwise direction, as indicated by the arrow F in FIGS. 5A and 5B, acts on the actuator 11. That is, the force to cause the actuator 11 to change its orientation in the direction opposite to the closed position acts on the actuator 11. Therefore, even if an external force such as vibration, shock, or the like is applied to the connector 10, the actuator 11 does not unnecessarily change its position to the closed position. For example, when inserting a flat cable into the connector 10, even if the flat cable abuts on the actuator 11, the actuator 11 maintains its position, and does not move to the closed position as indicated by the chain double-dashed line G in FIG. 5B.

It is possible to easily adjust the positional relationship with respect to the direction of insertion-and-extraction of the flat cable between the point of action of the force indicated by the arrow D and the point of action of the force indicated by the arrow E, by changing, for example, the cross-sectional shape of the first shafts 13a in order to change its position in which the lower surfaces of the first shafts 13a abut on the abutting surfaces of the first bearing parts 25. Similarly, it is possible to adjust the scale of the moment indicated by the arrow F by adjusting the positional relationship with respect to the direction of insertion-and-extraction of the flat cable between the point of action of the force indicated by the arrow D and the point of action of the force indicated by the arrow E. As can be seen from FIGS. 5a and 5b, first shafts 13a have noncircular cross sections with the contact points shown at the positional relationship of arrow E forward or ahead of the relative position of the centerline of second shafts 13b which is shown by arrow D.

As described above, if the ends of the first shafts 13a abut on the convex portions 36c being formed on the side parts 36 of the housing 31, it is also possible to retain the actuator 11 in the open position. For this reason, combined with the action of the force indicated by the arrow E, it is possible to more surely retain the actuator 11 in the open position.

Thus, in the present preferred embodiment, the actuator 11 maintains its orientation in the open position under the moment generated by the forces exerted on the first shafts 13a and the second shafts 13b by the first bearing parts 25 and the second bearing parts 54a respectively.

This can prevent the actuator 11 from unnecessarily changing its position to the closed position without complicating the construction of the connector 10. Then, this can downsize the connector 10, thereby enhancing the operability of the connector 10.

In the closed position, the force exerted on the first shafts 13a by the first bearing parts 25 and the force exerted on the second shafts 13b by the second bearing parts 54a act in opposite directions each other, and there is a displacement with regard to the direction of insertion-and-extraction of the flat cable between the point of action of the force exerted on the first shafts 13a by the first bearing parts 25 and the point of action of the force exerted on the second shafts 13b by the second bearing parts 54a. For this reason, a moment to maintain the orientation of the actuator 11 being situated in the open position is generated.

Furthermore, in the open position, the point of action of the force exerted on the first shafts 13a by the first bearing parts 25 is located ahead of the point of action of the force exerted on the second shafts 13b by the second bearing parts 54a, with respect to the direction of movement of the front end of the main body 15 in case that the actuator 11 changes its orientation from the open position to the closed position. Therefore, the moment as indicated by the arrow F in FIGS. 5A and 5B, to render the actuator 11 to change its orientation in a clockwise direction, acts on the actuator 11.

Further, in the open position, under the force exerted on the first shafts 13a by the first bearing parts 25 and the force exerted on the second shafts 13b by the second bearing parts 54a, the force to render the actuator 11 to change its orientation in the direction opposite to the open position acts on the actuator 11. Therefore, even if an external force such as vibration, shock, or the like is applied to the connector 10, the actuator 11 does not unnecessarily change its orientation to the closed position.

Furthermore, in the open position, the difference in height between the positions of the points at which first shafts 13a abut on the first bearing parts 25 and the positions of the points at which the second shafts 13b abut on the second bearing parts 54a is larger than the difference in height between the positions of the points at which the first bearing parts 25 abut on the first bearing parts 13a and the positions of the points at which the second bearing parts 54a abut on the second shafts 13b, when the actuator 11 is removed. Hence, the downward force as indicated by the arrow D in FIG. 5A is generated by spring forces such that the flexibly-deformed upper arm parts 54 exert in order to return to the shape that it used to have, and as the reaction force against said forces, the upward force as indicated by the arrow E in FIG. 5B is generated.

While the present invention has been described with reference to certain embodiments, it will be understood by those skilled in the art that various changes and substitutions may be made and equivalents may be used without departing from the spirit and scope of the invention. It is therefore intended that the invention not be limited to the particular embodiment disclosed, but that the invention will include all embodiments falling within the scope of the appended claims.

What is claimed is:

1. A cable connector comprising:
a housing provided with an inserting hole through which a flat cable having lead-wires is inserted;
terminals being mounted on the housing for electrical connection to the lead-wires of the flat cable;
an actuator moveable between a first position to enable insertion of the flat cable and a second position to connect the lead-wires of the inserted flat cable to the terminals, the actuator having a main body nearly parallel to a direction of insertion-and-extraction of the flat cable in the second position, first shafts disposed respectively on opposite sides of the main body and second shafts disposed in positions for engaging at least part of the terminals; and
auxiliary connector securing members mounted respectively on opposite sides of the housing, wherein:
the auxiliary connector securing members have first bearing parts respectively supporting the first shafts;
said part of the terminals having second bearing parts respectively supporting the second shafts, wherein:
the actuator maintains its orientation in the first position under a moment generated by forces on said first shafts and said second shafts which are exerted respectively by the first bearing parts and the second bearing parts.

2. The cable connector according to claim 1 wherein,
with said actuator in the first position, a difference in height between positions of points at which the first shafts abut on the first bearing parts and positions of points at which the second shafts abut on the second bearing parts is larger than a difference in height between positions of points at which the first bearing parts abut on the first shafts and positions of points at which the second bearing parts abut on the second shafts, when the actuator is removed;
forces exerted on the first shafts by the first bearing parts and forces exerted on the second shafts by the second bearing parts are opposed to each other, and a point of action of the forces exerted on the first shafts by the first bearing parts is located ahead of a point of action of the forces exerted on the second shafts by the second bearing parts, with respect to a direction of movement of a front end of the main body when the actuator changes the orientation thereof from the first position to the second position; and
under the forces exerted on the first shafts by the first bearing parts and the forces exerted on the second shafts by the second bearing parts, a force to change the orientation thereof in the direction opposed to the second position acts on the actuator.

3. The cable connector according to claim 1 or 2 wherein,
the housing has concave portions and convex portions being formed at side parts respectively;
in the second position, the first shafts are accommodated in the concave portions respectively; and
in the first position, ends of the first shafts abut on the convex portions respectively.
